(19) United States
(12) Patent Application Publication
(10) Pub. No.: US 2025/0249843 A1
(43) Pub. Date: Aug. 7, 2025

(54) RESIN RAIL GARNISH

(71) Applicant: TOYOTA JIDOSHA KABUSHIKI KAISHA, Aichi-ken (JP)

(72) Inventor: Motoya SAKABE, Nissin-shi (JP)

(21) Appl. No.: 19/039,789

(22) Filed: Jan. 29, 2025

(30) Foreign Application Priority Data
Feb. 7, 2024 (JP) 2024-017039

(51) Int. Cl. B60R 13/04

(52) U.S. Cl. CPC B60R 13/04

(57) ABSTRACT

A resin rail garnish is provided along both an A pillar and a roof side rail of a vehicle, and a garnish inner member disposed on a vehicle interior side of the rail garnish. The garnish inner member is divided into at least two or more parts in a vehicle longitudinal direction.

### CROSS REFERENCE TO RELATED APPLICATION

This application claims priority to Japanese Patent Application No. 2024-017039 filed on Feb. 7, 2024, which is incorporated herein by reference in its entirety including the specification, claims, drawings, and abstract.

### TECHNICAL FIELD

The present disclosure relates to a resin rail garnish provided along both an A pillar and a roof side rail of a vehicle.

### BACKGROUND

The resin rail garnish is provided along the A pillar and the roof side rail of the vehicle (for example, JP 2019-026239 A). The resin rail garnish is a decorative member that decorates the upper end portion of the vehicle side surface, and improves the design of the vehicle side surface.

Since the resin rail garnish is made of resin, it may thermally expand in a high temperature environment. Therefore, assuming that the resin rail garnish thermally expands in the vehicle front-rear direction, a gap is provided in advance between the end portion of the resin rail garnish in the vehicle front-rear direction and the parting line of the vehicle body. Specifically, for example, a gap is provided in advance between the front end portion of the resin rail garnish and the parting line of the fender. Further, a gap is provided in advance between the rear end portion of the resin rail garnish and the parting line of the back door.

### SUMMARY

However, as described above, since a gap is provided in advance between the end portion of the resin rail garnish in the vehicle longitudinal direction and the parting line of the vehicle body, the design of the vehicle is impaired.

Therefore, an object of the present disclosure is to provide a resin rail garnish that can improve the design of a vehicle by reducing a gap between an end portion in a vehicle front-rear direction and a parting line of a vehicle body.

A resin rail garnish according to the present disclosure, provided along both an A pillar and a roof side rail of a vehicle comprises a garnish inner member disposed on a vehicle interior side of the rail garnish. The garnish inner member is divided into at least two or more parts in a vehicle longitudinal direction.

With the above configuration, the dividing gap of the garnish inner member becomes the fragile portion. As a result, when the garnish inner member thermally expands in a high temperature environment, the garnish inner member deforms so as to be slightly bent at the dividing gap. As a result, the gap between the end portion of the garnish inner member in the vehicle longitudinal direction and the parting line of the vehicle body can be reduced, and the design of the vehicle can be improved.

A resin rail garnish according to the present disclosure, the garnish inner member is divided at least at a boundary between the A pillar and the roof side rail.

With the above configuration, the boundary between the A pillar having the largest curvature in the vehicle front-rear direction of the garnish inner member and the roof side rail becomes the weak portion. Thus, when the garnish inner member thermally expands in a high temperature environment, the garnish inner member deforms so that the boundary between the A pillar, which is the fragile portion, and the roof side rail slightly expands upward. As a result, the gap between the end portion of the garnish inner member in the vehicle longitudinal direction and the parting line of the vehicle body can be reduced, and the design of the vehicle can be improved.

A resin rail garnish according to the present disclosure, the garnish inner member is further divided at a position located on a vehicle rear side of the boundary between the A pillar and the roof side rail. A dividing gap formed at the position on the vehicle rear side of the boundary between the A pillar and the roof side rail is smaller than a dividing gap formed at the boundary between the A pillar and the roof side rail.

With the above configuration, the boundary between the A pillar having the largest curvature in the vehicle front-rear direction of the garnish inner member and the roof side rail becomes the weakest fragile portion. As a result, when the garnish inner member thermally expands in a high temperature environment, the garnish inner member deforms so that the boundary between the A pillar, which is the weakest fragile portion, and the roof side rail is preferentially slightly expanded upward.

According to the resin rail garnish of the present disclosure, it is possible to eliminate a gap between the end portion in the vehicle front-rear direction and the parting line of the vehicle body, and to improve the design of the vehicle.

### BRIEF DESCRIPTION OF DRAWINGS

FIG. 1 is a side view of a vehicle according to an embodiment.

FIG. 2 is a side view showing a resin rail garnish as an example of the embodiment.

FIG. 3 is a perspective view of a portion A of FIG. 2 as viewed from the back side.

FIG. 4 is a perspective view of a portion B of FIG. 2 as viewed from the back side.

FIG. 5 is a perspective view of a portion C of FIG. 2 as viewed from the back side.

### DESCRIPTION OF EMBODIMENTS

Hereinafter, an example of an embodiment of the present disclosure will be described in detail. In the following description, specific shapes, materials, directions, numerical values, and the like are examples for facilitating understanding of the present disclosure, and can be appropriately changed according to applications, purposes, specifications, and the like.

### Resin Rail Garnish

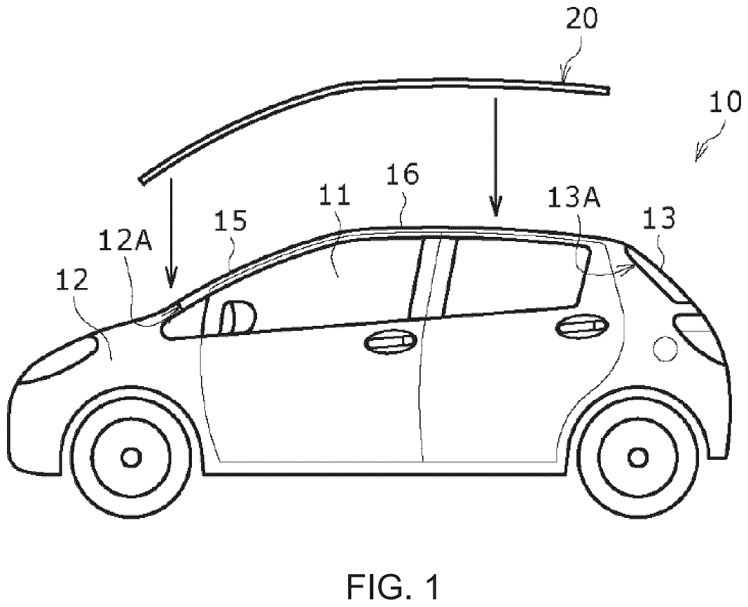

A resin rail garnish 20 as an example of an embodiment will be described with reference to FIG. 1.

The resin rail garnish 20 is a decorative member that decorates the upper end portion of the side surface of the vehicle 10, and improves the design of the side surface of the vehicle 10. According to the resin rail garnish 20 of the present embodiment, although details will be described later, the design of the vehicle 10 can be improved by reducing the gap between the end portion of the resin rail garnish 20 in the vehicle longitudinal direction and the parting line of the vehicle body.

The vehicle 10 of the present embodiment is, for example, a hatchback, and has a flip-up type or sideways opening type back door 13. However, the vehicle 10 of the present invention is not limited to the hatchback, and may be a notchback or a station wagon.

The resin rail garnish 20 is provided along the vehicle front-rear direction at both end portions in the vehicle width direction of the vehicle 10 and at an upper end portion in the vehicle height direction. More specifically, the resin rail garnish 20 is provided along the A pillar 15 and the roof side rail 16 of the vehicle 10.

The A pillars 15 are disposed on the left and right sides of the forefront surface of the vehicle cabin 11 of the vehicle 10, and hold a front window (not shown) and a roof (not shown). According to the A-pillar 15, it is possible to secure the survival space of the occupant by improving the durability against an impact such as a collision from the front. The A pillar 15 may also be referred to as a front pillar.

The roof side rails 16 are frames forming a vehicle skeleton, and are provided so as to extend in the vehicle front-rear direction so as to sandwich the roof in the vehicle width direction. The roof side rail 16 is made of metal and has a closed cross section.

The resin rail garnish 20 is provided from the parting line 12A of the fender 12 to the parting line 13A of the back door 13. In other words, the front end portion of the resin rail garnish 20 is formed up to the parting line 12A of the fender 12. The rear end portion of the resin rail garnish 20 is formed up to the parting line 13A of the back door 13. However, the resin rail garnish 20 of the present invention is not limited to the resin rail garnish 20 of the present embodiment. The end portions of the resin rail garnish 20 of the present invention are preferably formed up to the parting line of the vehicle body (outer plate or exterior component).

The resin rail garnish 20 is made of resin. Therefore, thermal elongation may occur in a high temperature environment. Therefore, conventionally, assuming that the resin rail garnish 20 thermally expands in the vehicle front-rear direction, a gap is provided between an end portion of the resin rail garnish 20 in the vehicle front-rear direction and a parting line of the vehicle body. Specifically, for example, a gap is provided between the front end portion of the resin rail garnish 20 and the parting line 12A of the fender 12. Further, a gap is provided between the rear end portion of the resin rail garnish 20 and the parting line 13A of the back door 13.

However, as described above, since the gap is provided between the end portion of the resin rail garnish 20 in the vehicle longitudinal direction and the parting lines 12A and 13A, the design of the vehicle 10 is impaired. Therefore, in the resin rail garnish 20 of the present embodiment, although details will be described later, by dividing the garnish inner member 30 in the vehicle front-rear direction, it is possible to reduce a gap between the end portion of the resin rail garnish 20 in the vehicle front-rear direction and the parting lines 12A and 13A.

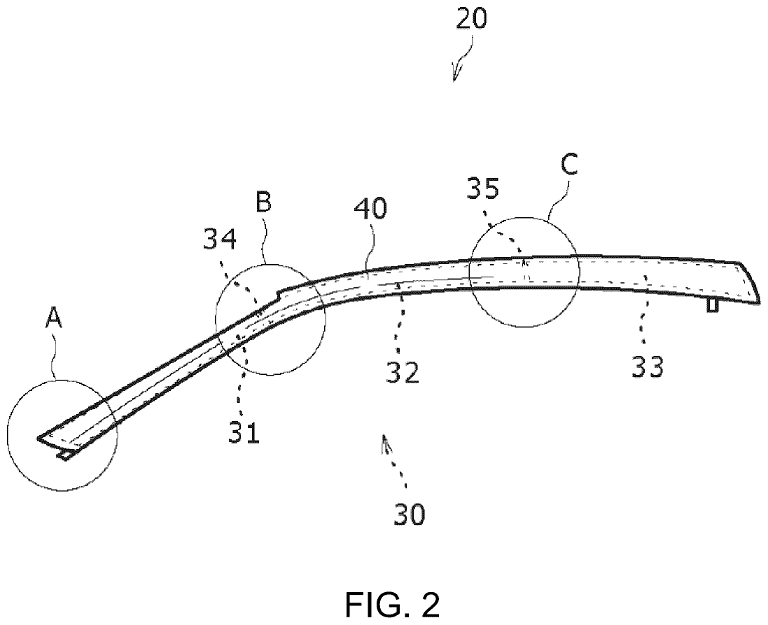

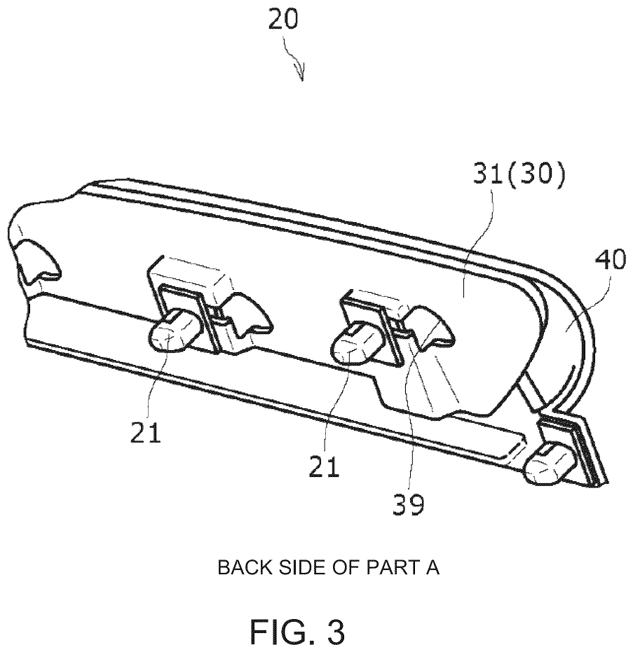

The resin rail garnish 20 will be described in more detail with reference to FIGS. 2 and 3.

The resin rail garnish 20 includes a garnish inner member 30 forming an inner side of the vehicle and a garnish outer member 40 forming an outer side of the vehicle. The garnish inner member 30 and the garnish outer member 40 are joined by welding.

The garnish inner member 30 is a portion attached to the clip 21 provided on the A pillar 15 and the roof side rail 16 of the vehicle 10. A fitting hole 39 into which the clip 21 is fitted is formed in the garnish inner member 30 (a first inner portion 31 described later in FIG. 3). The garnish inner member 30 will be described in more detail later.

The garnish outer member 40 is a portion that forms a decorative surface of the resin rail garnish 20. By configuring the garnish inner member 30 and the garnish outer member 40 as separate members, the garnish inner member 30 can have a complicated shape having the fitting hole 39 and the like, and the garnish outer member 40 can have a simple shape. As a result, sink marks are unlikely to occur when the garnish outer member 40 is molded, and the design is not impaired.

### Garnish Inner Member

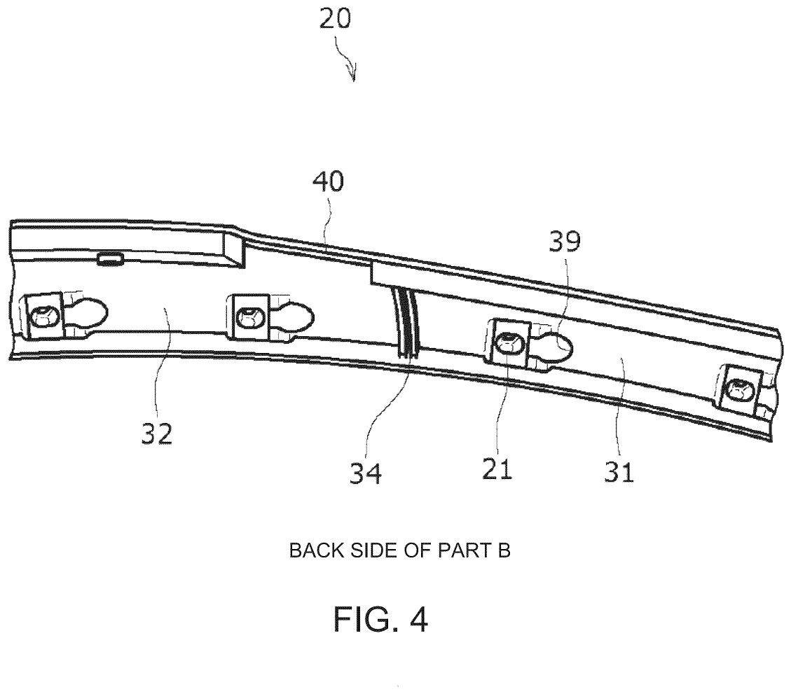

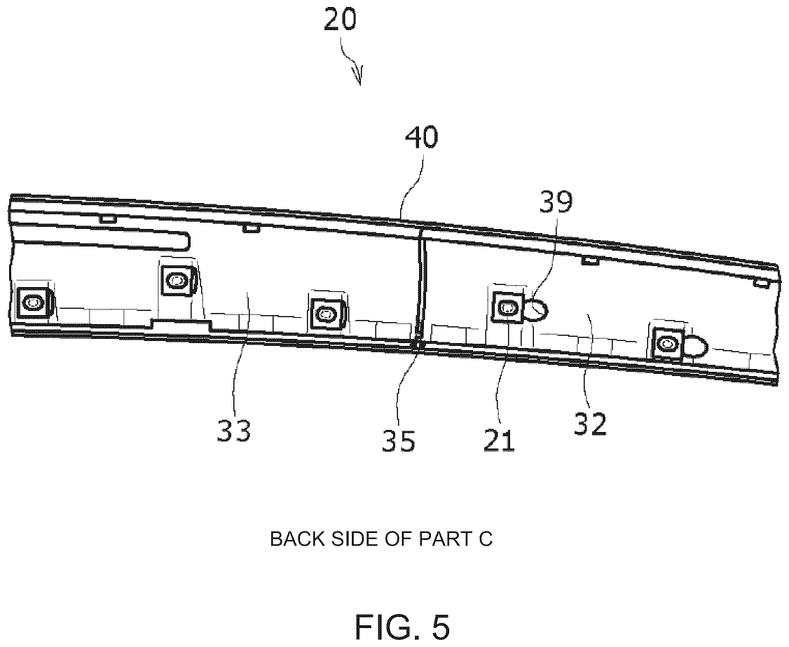

The garnish inner member 30 will be described in detail with reference to FIGS. 2, 4, and 5.

The garnish inner member 30 is divided into three parts of a first inner part 31, a second inner part 32, and a third inner part 33 in order from the front side in the vehicle front-rear direction. A front dividing gap 34 is formed between the first inner portion 31 and the second inner portion 32. A rear dividing gap 35 is formed between the second inner portion 32 and the third inner portion 33.

With the above configuration, the front dividing gap 34 and the rear dividing gap 35 (hereinafter, referred to as dividing gaps) of the garnish inner member 30 become fragile portions. As a result, when the garnish inner member 30 thermally expands in a high temperature environment, the garnish inner member 30 deforms so that the dividing gap slightly bends. As a result, the gap between the end portion of the garnish inner member 30 in the vehicle front-rear direction and the parting lines 12A and 13A can be reduced. Thus, the design of the vehicle 10 can be improved.

The first inner portion 31 and the second inner portion 32 are divided at a boundary between the A pillar 15 and the roof side rail 16. In other words, the front dividing gap 34 formed between the first inner portion 31 and the second inner portion 32 is located at the boundary between the A pillar 15 and the roof side rail 16.

With the above configuration, the front dividing gap 34 having the largest curvature in the vehicle front-rear direction of the garnish inner member 30 becomes the fragile portion. As a result, when the garnish inner member 30 thermally expands in a high temperature environment, the garnish inner member 30 deforms so that the front dividing gap 34, which is a fragile portion, slightly expands upward. As a result, the gap between the end portion of the garnish inner member 30 in the vehicle front-rear direction and the parting lines 12A and 13A can be reduced. Thus, the design of the vehicle 10 can be improved. Since the amount of bulging is small, the design of the vehicle 10 is not affected.

The rear split gap 35 formed between the second inner portion 32 and the third inner portion 33 is smaller than the front split gap 34 formed between the first inner portion 31 and the second inner portion 32.

With the above configuration, the front dividing gap 34 having the largest curvature in the vehicle front-rear direction of the garnish inner member 30 becomes the weakest fragile portion. As a result, when the garnish inner member 30 thermally expands in a high temperature environment, the garnish inner member 30 deforms so that the front dividing gap 34, which is the weakest fragile portion, preferentially slightly bulges upward. Since the amount of bulging is small, the design of the vehicle 10 is not affected.

The garnish outer member 40 is not divided like the garnish inner member 30. Thus, the appearance design of the resin rail garnish 20 is not impaired. When the garnish outer member 40 thermally expands in a high temperature environment, it bends according to the deformation of the garnish inner member 30.

Note that the present disclosure is not limited to the above-described embodiments and modifications thereof, and it is needless to say that various modifications and improvements can be made within the scope of the matters described in the claims of the present application.

1. A resin rail garnish provided along both an A pillar and a roof side rail of a vehicle comprising;
a garnish inner member disposed on a vehicle interior side of the rail garnish, wherein
the garnish inner member is divided into at least two or more parts in a vehicle longitudinal direction.

2. The rail garnish according to claim 1,
wherein the garnish inner member is divided at least at a boundary between the A pillar and the roof side rail.

3. The rail garnish according to claim 2,
wherein the garnish inner member is further divided at a position located on a vehicle rear side of the boundary between the A pillar and the roof side rail, and
a division gap formed at the position on the vehicle rear side of the boundary between the A pillar and the roof side rail is smaller than a division gap formed at the boundary between the A pillar and the roof side rail.
